(19) United States
(12) Patent Application Publication
(10) Pub. No.: US 2016/0143318 A1
(43) Pub. Date: May 26, 2016

(54) MULTI-TEXTURE PET TREATS AND METHODS OF MAKING SAME

(71) Applicant: NESTEC SA, Vevey (CH)

(72) Inventors: Lei Xu, Nanjing (CN); Chung Hsuan Jarvis, St. Louis, MO (US)

(21) Appl. No.: 14/946,238

(22) Filed: Nov. 19, 2015

Related U.S. Application Data
(60) Provisional application No. 62/083,465, filed on Nov. 24, 2014.

(51) Int. Cl. A23K 1/10

(52) U.S. Cl. CPC A23K 1/10; A23K 1/004

(57) ABSTRACT

Pet treats have different textures therein and can be made by coating a first meat, such as a single unitary piece of fresh meat, with small pieces of a second meat, such as dried particles of the second meat. The first and second meats can be the same type or different types of meat relative to each other, for example any type of meat suitable for pets such as chicken, beef, pork, lamb, turkey, duck, goose, rabbit or even fish. A particularly preferred embodiment of the pet treat is a chicken breast or chicken tender coated with small pieces of dehydrated chicken to resemble “fried” chicken.

### CROSS REFERENCE TO RELATED APPLICATIONS

This application claims priority to U.S. Provisional Application No. 62/083,465 filed Nov. 24, 2014, the disclosure of which is incorporated herein by this reference.

### BACKGROUND

The present disclosure relates generally to pet treats having different textures therein and further relates to methods of making such pet treats. More specifically, the present disclosure is directed to a piece of meat coated with breading made from the same or a different meat, for example a chicken breast or chicken tender coated with small pieces of dehydrated chicken to resemble “fried” chicken.

There are many pet food products on the market. The pet food products can be in a variety of shapes and structures such as kibbles, biscuits, rawhide products and meat emulsion products. Typically, these pet food products are homogenous in that they are usually made from the same materials throughout the product. Even pet food products that appear to be made from different base materials are usually made by providing the same base materials with different colors so as to give the pet food products a multi-component appearance. Although pet food components with different textures may be sold together as separate pieces (e.g., kibbles and bits), there are no satisfactory multi-textured pet food products formed entirely in one piece currently on the market.

Moreover, pet owners have a tendency to feed their pets with the food that they enjoy. However, food that has a taste and an appearance that is enjoyable for a pet, such as food formulated for human consumption, typically is not formulated for pet consumption and can be unhealthy for the pet and/or can cause discomfort in the pet.

### SUMMARY

The present disclosure provides pet treats having different textures therein and methods of making such pet treats. As a non-limiting example, the present disclosure provides a method in which small pieces of dried chicken are used to coat a piece of fresh chicken, and then the coated chicken is dehydrated.

Accordingly, in a general embodiment, the present disclosure provides a pet treat comprising: a first meat; and dry pieces of a second meat that form a coating on the first meat, the dry pieces of the second meat are smaller in size than the first meat, and the coating has a different texture than the first meat.

In an embodiment, the coating does not contain flour.

In an embodiment, the pet treat has not been fried.

In an embodiment, the first meat has a form of single unitary piece. The single unitary piece of the first meat can be a chicken inner fillet or a skinned boneless chicken breast.

In an embodiment, each of the first and second meats are a type of meat selected from the group consisting of chicken, beef, pork, lamb, turkey, duck, goose, rabbit, fish and combinations thereof. The type of meat can be different for the first meat relative to the second meat. The type of meat can be the same for the first meat relative to the second meat.

In an embodiment, the first and second meats are chicken. The pet treat can have an appearance of fried chicken.

In another embodiment, the present disclosure provides a method of making a pet treat having at least two textures. The method comprises the steps of: mixing a first meat with dry pieces of a second meat such that the first meat is coated with the dry pieces of the second meat; and drying the first meat coated with the second meat.

In an embodiment, the drying comprises subjecting the first meat that is coated with the dry pieces of the second meat to a temperature of 200-220 ° C. for a time period of 4-6 hours.

In an embodiment, after the drying, the first meat that is coated with the second meat has a moisture content of about 10.7-about 10.9%.

In an embodiment, the method comprises applying a polyol to the first meat before the mixing of the first meat with the dry pieces of a second meat.

In an embodiment, a ratio of the first meat to the second meat before the drying is about 10:1 by dry weight.

In an embodiment, a ratio of the first meat to the second meat after the drying is about 3.1:1 by dry weight.

In an embodiment, the dry pieces of the second meat are particles having a diameter between about 1.5 mm and about 7.0 mm.

In an embodiment, the method does not include frying the first meat, the second meat, or the first meat coated with the second meat.

In an embodiment, the method comprises dehydrating the second meat and grinding the dehydrated second meat to form the dry pieces of the second meat.

In an embodiment, the first meat has not been cooked before the mixing and the drying.

In another embodiment, the present disclosure provides a method of providing a pet treat having an appearance of human food to a pet. The method comprises administering to the pet a pet food comprising a single unitary piece of a first meat coated with dry pieces of a second meat, the coating of the dry pieces of the second meat has a different texture than the single unitary piece of the first meat.

An advantage of the present disclosure is to provide a novel pet treat.

Another advantage of the present disclosure is to deliver unique feeding experiences to a consumer's pet.

Still another advantage of the present disclosure is to provide excitement to a pet owner based on their pet being able to consume a pet food that closely simulates human food.

Yet another advantage of the present disclosure is to allow a pet owner to feed their pet with food resembling food that is enjoyed by the pet owner themselves.

Another advantage of the present disclosure is to provide a product resembling real fried chicken but without having been actually fried or including a flour-based coating.

Still another advantage of the present disclosure is to allow consumers to treat their pets with a special treat that looks and feels like a piece of fried chicken while knowing that the pet is consuming a treat that is healthier than a real piece of fried chicken.

Yet another advantage of the present disclosure is to utilize simple, existing ingredients used in current pet food products to create a new product that does not exist in today's market.

Still another advantage of the present disclosure is to provide a pet treat that looks and feels like real fried chicken, not pet food.

Additional features and advantages are described herein, and will be apparent from the following Detailed Description and the Figures.

### BRIEF DESCRIPTION OF THE FIGURES

FIG. 1 is a photograph of the coating used in the example disclosed herein.

FIG. 2 is a photograph of a piece of meat receiving the coating in the example disclosed herein.

FIG. 3 is a photograph of the coated meat on a rack in the example disclosed herein.

FIGS. 4-7 are photographs of the resultant pet foods in the example disclosed herein.

### DETAILED DESCRIPTION

As used in this disclosure and the appended claims, the singular forms “a,” “an” and “the” include plural referents unless the context clearly dictates otherwise. Thus, for example, reference to “a meat” includes two or more meats. The term “and/or” used in the context of “X and/or Y” should be interpreted as “X,” or “Y,” or “X and Y.”

As used herein, “about” is understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All percentages expressed herein are by weight of the total weight of the composition unless expressed otherwise. When reference is made to the pH, values correspond to pH measured at 25° C. with standard equipment.

The terms “food,” “food product” and “food composition” mean a product or composition that is intended for ingestion by an animal, including a human, and provides at least one nutrient to the animal. The term “pet food” means any food composition intended to be consumed by a pet. The term “companion animal” means a dog or a cat. The compositions disclosed herein may lack any element that is not specifically disclosed herein. Thus, a disclosure of an embodiment using the term “comprising” includes a disclosure of embodiments “consisting essentially of” and “consisting of” the components identified.

In an aspect of the present disclosure, a pet food comprises a first meat having a coating of a second meat, preferably without the pet food or its components having been fried and without having a flour-based batter coating. Preferably, the first meat is a single unitary piece of meat and the coating of the second meat is made of dry pieces of the second meat, for example fine particles thereof (e.g. particles between about 1.5 mm and about 7.0 mm in diameter). In a preferred embodiment, the dry pieces of the second meat are coated directly on the first meat in contact therewith. The first meat can be the same type of meat as the second meat (chicken, beef, pork, lamb, turkey, duck, goose, rabbit, fish, etc.) or the first meat can be a different type of meat relative to the second meat.

Non-limiting examples of suitable meat materials include meat (i.e. skeletal tissue and non-skeletal muscle) from mammals, fish and fowl (e.g. poultry, beef, pork, lamb and fish, especially those types of meats suitable for pets) and also include meat by-products (i.e. the non-rendered clean parts, other than meat, derived from slaughtered mammals, fowl or fish). More specific non-limiting examples include whole-carcass beef and mutton, lean pork trim, beef shanks, veal, beef and pork cheek meat; meat by-products such as lips, tripe, hearts, and tongues; and meat by-products approved for use in animal foods, such as mechanically deboned beef, chicken, or fish; or beef and pork liver, lungs, and kidney.

To form the pet food, the first meat can be mixed with a polyol, for example in a tumbler, to maximize the adhesiveness of the first meat. In an embodiment, the first meat is raw and has not been cooked, for example fresh meat or previously fresh meat that has subsequently been stored at a refrigerated or frozen temperature. Preferably the first meat has the form of a fillet, for example a piece or slice of boneless meat. Non-limiting examples of suitable polyols include for example glycerol, arabitol, erythritol, xylitol, ribitol, sorbitol, dulcitol, mannitol, isomalt, maltitol and lactitol. Preferably, glycerol is used.

Then the first meat can be mixed with pieces of the second meat such that the first meat is coated with the second meat. The pieces of the second meat can be in the form of particles and preferably are dry (e.g. a moisture content less than about 20%, preferably less than about 15%, more preferably less than about 10%, most preferably less than about 5%). The pieces of the second meat can be obtained from other pet food manufacturing processes (e.g. the pieces of the second meat can be the scraps and fines from other pet food manufacturing processes) and/or can be dried meat that has been subjected to grinding. The pieces of the second meat can be poured through one or more sieves to obtain pieces having a desired size.

The term “coating” or “coated” in reference to the first meat means that the first meat is completely or substantially covered by the second meat. The first meat is “substantially coated” if less than 10% of the first meat is visible on the surface of the pet food, preferably less than 5%, more preferably less than 2%, most preferably less than 1%.

The first meat can be coated in the second meat by mixing the first meat and the second meat manually by hand. Additionally or alternatively, the mixing can employ mechanical means. In an embodiment, the first and second meats are placed in a mixing bowl, and the first meat and/or the second meat are moved around the mixing bowl such that the second meat adheres to the first meat to thereby coat the first meat. Preferably the mixing is gentle and involves a low amount of force such that the first meat maintains its form (e.g. is not broken into smaller pieces). In an embodiment, the coating consists of the second meat.

The coated meat can then be positioned on a rack for drying. The rack can optionally be coated with an oil such as soybean oil. In an embodiment, the coated meat consists of the first meat, the second meat and optionally glycerin before the drying. As a non-limiting example of suitable drying conditions, the drying of the coated meat can be at a temperature of 200-220° C. for a time period of 4-6 hours. As another non-limiting example of suitable drying conditions, the drying of the coated meat can be performed to obtain a moisture content of 10.7%-10.9% of the coated meat.

The weight ratio of the first meat to the second meat can be approximately 10:1 before drying. After drying, this weight ratio can be about 3.1:1 by dry weight. In an embodiment, the resultant pet treat consists of the first meat, the second meat and optionally glycerin.

The dried coated meat can be allowed to cool and then can be removed from the rack.

In a particularly preferred embodiment, the pet food is a chicken piece that has a fried appearance and a crunchy coating without having been fried and without having a flour-based batter coating. For example, a chicken inner fillet or a sliced skinned boneless chicken breast can be used as the first meat. The chicken inner fillet or breast can be mixed with glycerin, for example in a tumbler, to maximize the adhesiveness of the chicken fillet or breast. After tumbling, the chicken fillet or breast can be mixed with a coating of dried chicken particles, for example dried chicken particles sieved through a screen having openings with diameters between about 1.5 mm and about 7.0 mm. The coated meat can then be positioned on a rack for drying, for example a rack coated with an oil such as soybean oil. The drying can form the chicken piece having a fried appearance and a crunchy coating.

### Example

By way of example and not limitation, the following example is illustrative of embodiments of the present disclosure.

The pet food of this example was made by the following general process: a chicken fillet or skinned boneless breast was received, placed in cold storage, tumbled with glycerin, mixed with a coating, racked, dehydrated, cooled, de-racked, subjected to metal detecting, and then packed.

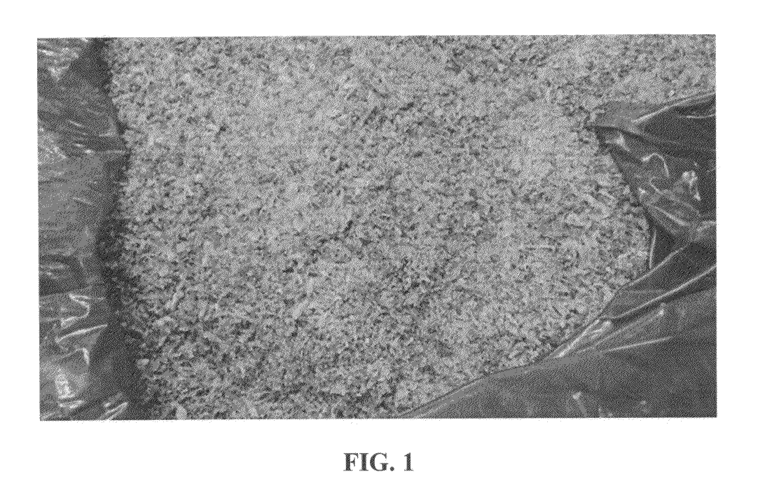

More specifically, one batch used chicken inner fillet, and another batch used sliced skinned boneless chicken breast as starting materials. The coating material (“breading”) was dried chicken pieces sieved between the screen sizes of 1.5 mm and ˜7.0 mm (FIG. 1).

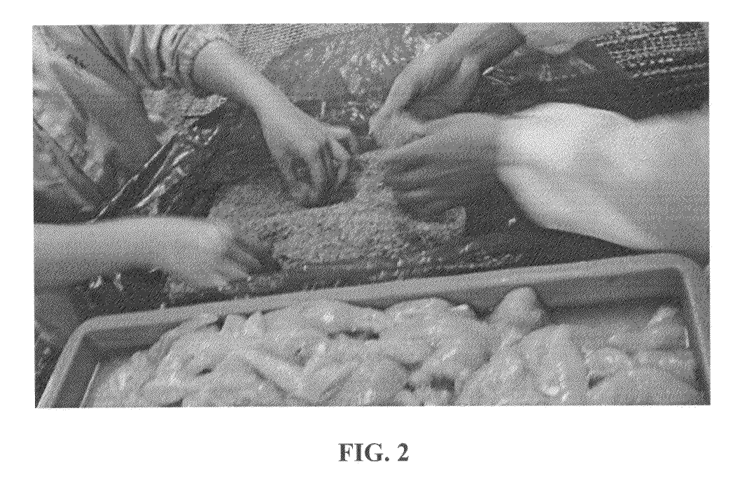

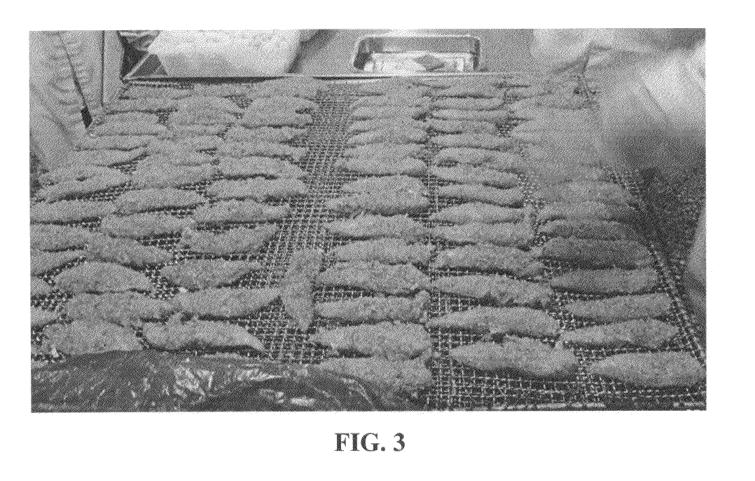

The chicken fillet or breast was first mixed with glycerin using a tumbler. The mixing time can be optimized to maximize the “stickiness” of the chicken. After tumbling, the chicken fillet or breast was mixed with the coating by putting the meat pieces into a basin and mixing with coating material (FIG. 2). The chicken fillet or breast with the coated material was then put on a soybean oil coated rack for drying (FIG. 3).

The ratio of raw tumbled meat to coating was approximately 10:1 (w/w). After drying, this ratio was calculated as about 3.1:1 by dry weight. In general, the breading sticks well with the chicken fillet or breast, without excessive fines build-up after drying.

The de-racking of the coated filets was very easy. The drying racks were coated with soybean oil before use, but the inventors believe that the de-racking would be similarly easy even without soybean oil as release agent.

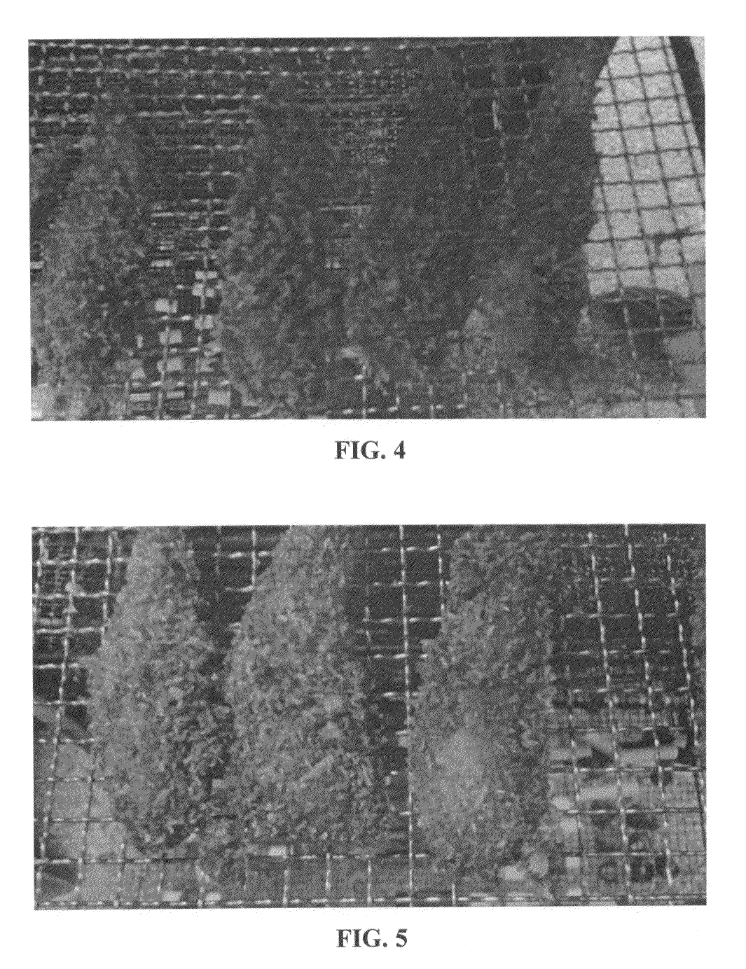

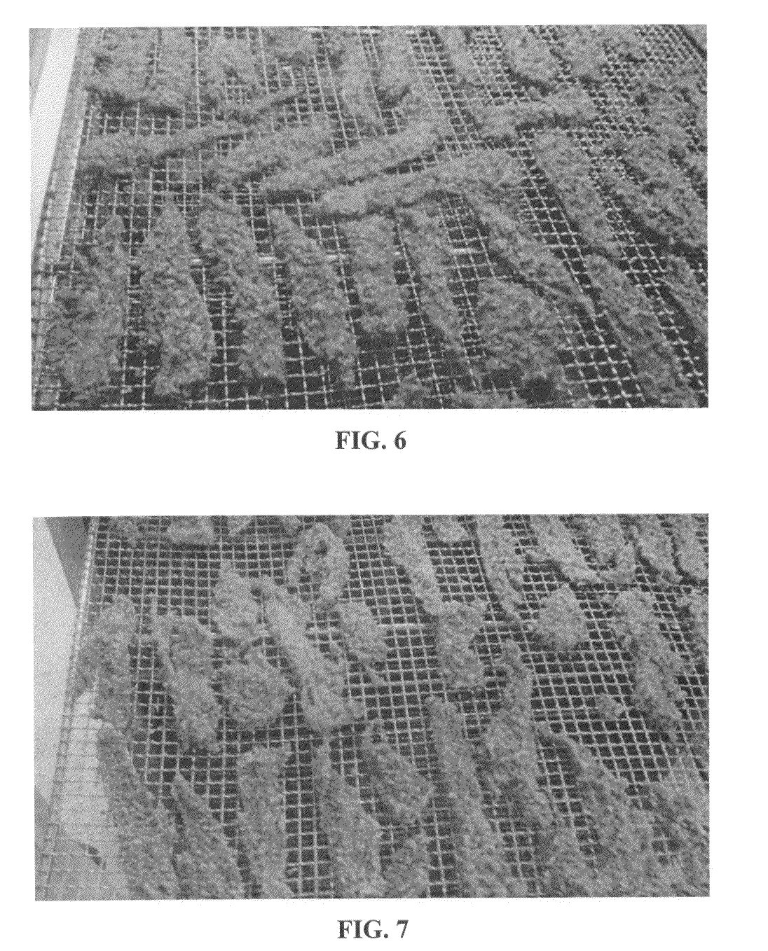

The resultant pet foods are shown in FIGS. 4 and 5 (coated fillet) and FIGS. 6 and 7 (coated breast).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A pet treat comprising:
a first meat; and
dry pieces of a second meat that form a coating on the first meat, the dry pieces of the second meat are smaller in size than the first meat, and the coating has a different texture than the first meat.

2. The pet treat of claim 1 wherein the coating does not contain flour.

3. The pet treat of claim 1 wherein the pet treat has not been fried.

4. The pet treat of claim 1 wherein the first meat has a form of single unitary piece.

5. The pet treat of claim 4 wherein the single unitary piece of the first meat is a chicken inner fillet or a skinned boneless chicken breast.

6. The pet treat of claim 1 wherein each of the first and second meats are a type of meat selected from the group consisting of chicken, beef, pork, lamb, turkey, duck, goose, rabbit, fish and combinations thereof.

7. The pet treat of claim 6 wherein the type of meat is different for the first meat relative to the second meat.

8. The pet treat of claim 6 wherein the type of meat is the same for the first meat relative to the second meat.

9. The pet treat of claim 1 wherein the first and second meats are chicken.

10. The pet treat of claim 9 wherein the pet treat has an appearance of fried chicken.

11. A method of making a pet treat having at least two textures, the method comprising the steps of:
mixing a first meat with dry pieces of a second meat such that the first meat is coated with the dry pieces of the second meat; and
drying the first meat coated with the second meat.

12. The method of claim 11 wherein the drying comprises subjecting the first meat that is coated with the dry pieces of the second meat to a temperature of 200-220° C. for a time period of 4-6 hours.

13. The method of claim 11 wherein, after the drying, the first meat that is coated with the second meat has a moisture content of about 10.7-about 10.9%.

14. The method of claim 11 comprising applying a polyol to the first meat before the mixing of the first meat with the dry pieces of a second meat.

15. The method of claim 11 wherein a ratio of the first meat to the second meat before the drying is about 10:1 by dry weight.

16. The method of claim 11 wherein a ratio of the first meat to the second meat after the drying is about 3.1:1 by dry weight.

17. The method of claim 11 wherein the dry pieces of the second meat are particles having a diameter between about 1.5 mm and about 7.0 mm.

18. The method of claim 11 wherein the method does not include frying the first meat, the second meat, or the first meat coated with the second meat.

19. The method of claim 11 comprising dehydrating the second meat and grinding the dehydrated second meat to form the dry pieces of the second meat.

20. The method of claim 11 wherein the first meat has not been cooked before the mixing and the drying.

21. A method of providing a pet treat having an appearance of human food to a pet, the method comprising administering to the pet a pet food comprising a single unitary piece of a first meat coated with dry pieces of a second meat, the coating of the dry pieces of the second meat has a different texture than the single unitary piece of the first meat.
